(19) United States
(12) Patent Application Publication
(10) Pub. No.: US 2009/0232417 A1
(43) Pub. Date: Sep. 17, 2009

(54) Method and Apparatus of Annotating Digital Images with Data

(75) Inventor: David Michael McMahan, Raleigh, NC (US)

Correspondence Address: COATS & BENNETT/SONY ERICSSON, 1400 CRESCENT GREEN, SUITE 300, CARY, NC, 27518, US

(73) Assignee: SONY ERICSSON MOBILE COMMUNICATIONS AB, Lund (SE)

(21) Appl. No.: 12/048,542

(22) Filed: Mar. 14, 2008

(51) Int. Cl. G06K 9/03

(52) U.S. Cl. 382/309

(57) ABSTRACT

A device is configured to capture a digital image, and to analyze the image to identify objects in the image. Metadata used to identify the objects may be generated when the digital image is captured and to annotate the digital image. The device may also save the metadata with the image or display the metadata with the image to a user. Such metadata may be used as an index to permit users to search for and locate archived images.

### TECHNICAL FIELD

The present invention relates generally to image capture devices that capture digital images, and particularly to those image capture devices that annotate the captured digital images with data.

### BACKGROUND

In the past decades, digital cameras have replaced conventional cameras that use film. A digital camera senses light using a light-sensitive sensor, and converts that light into digital signals that can be stored in memory. One reason that digital cameras are so popular is that they provide features and functions that film cameras do not. For example, digital cameras are often able to display newly captured image on it's display screen immediately after it the image is captured. This allows a user to preview the captured still image or video. Additionally, digital cameras can take thousands of images and save them to a memory card or memory stick. This permits users to capture images and video and then transfer them to an external device such as the user's personal computer. Digital cameras also allow users to record sound with the video being captured, to edit captured images for re-touching purposes, and to delete undesired images and video to allow the re-use of the memory storage they occupied.

However, the same features that make digital cameras so popular can also cause problems. Particularly, the large storage capacity of digital cameras allows users to take a large number of pictures. Given this capacity, it is difficult for users to locate a single image quickly because searching for a desired image or video requires a person to visually inspect the images.

### SUMMARY

The present invention provides an image capture device that can analyze a digital image, identify objects in the image, and generate metadata that can be stored with the image. The metadata may be used to annotate the digital image, and as an index to permit users to search for and locate images once they are archived.

In one embodiment, a controller analyzes a captured image to classify one or more objects in the image as being a dynamic object or a static object. Dynamic objects are those that have some mobility, such as people, animals, and cars. Static objects are those objects that have little or no mobility, such as buildings and monuments. Once classified, the controller selects a recognition algorithm to identify the objects.

For dynamic objects, the recognition algorithm may operate to identify a person's face, or to identify a profile or contour of an inanimate object such as a car. For static objects, the recognition algorithm may operate to identify an object based on information received from one or more sensors in the device. The sensors may include a Global Positioning Satellite (GPS) receiver that provides the geographical location of the device when the image is captured, a compass that provides a signal indicating an orientation for the device when the image was captured, and a distance measurement unit to provide a distance between the device and the object when the image was captured. Knowing the geographical location, the direction in which the device was pointed, and the distance to an object of interest when the image was captured could allow the controller to deduce the identity of the object.

Once identified, the device can display the digital image to the user and overlay the metadata on the displayed image. Additionally, the metadata may be associated with the image and saved in memory. This would allow a user who wishes to subsequently locate a particular image to query to a database for the metadata to retrieve the digital image.

### BRIEF DESCRIPTION OF THE DRAWINGS

FIG. 1 is a perspective view of a digital camera configured to annotate images according to one embodiment of the present invention.

FIG. 2 is a block diagram illustrating some of the component parts of a digital image capturing device configured to annotate images according to one embodiment of the present invention.

FIG. 3 is a perspective view of an annotated still image captured by a digital camera configured according to one embodiment of the present invention.

FIG. 4 is a flow chart illustrating a method by which an image may be annotated with metadata according to embodiments of the present invention.

FIG. 5 is a perspective view of a camera-equipped wireless communication device configured to annotate captured images according to one embodiment of the present invention.

FIG. 6 is a block diagram illustrating a network by which images and video captured by a camera-equipped wireless communication device may be transferred to an external computing device configured to annotate the images and video according to one embodiment of the present invention.

### DETAILED DESCRIPTION

The present invention provides a device that analyzes a digitally captured image to identify one or more recognizable objects in the image automatically. Recognizable subjects may include, but are not limited to, buildings or structures, vehicles, people, animals, and natural objects. Metadata identifying the objects may be associated with the captured image, as may metadata indicating a date and time, a shutter speed, a temperature, and range information. The device annotates the captured image with this metadata for display to the user. The device also stores the metadata as keywords with the captured image so that a user may later search on specific keywords to locate a particular image.

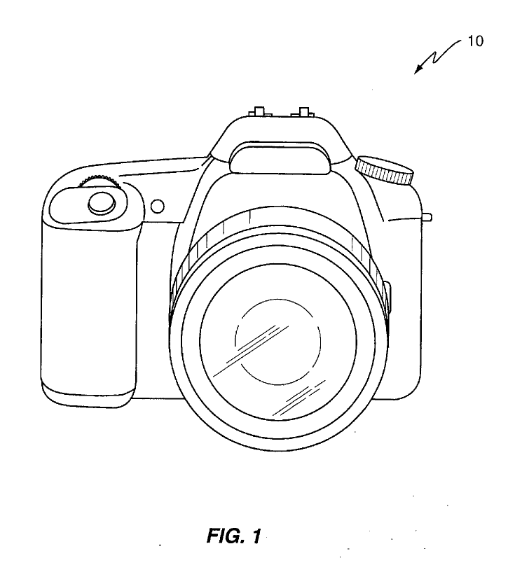

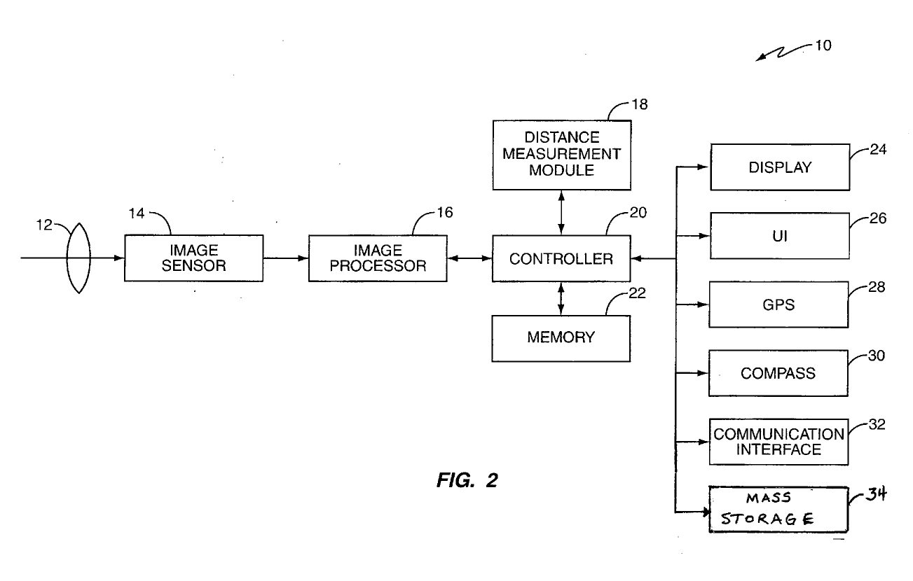

The device may be, for example, a digital camera 10 such as the one seen in FIGS. 1 and 2. Digital camera 10 typically includes a lens assembly 12, an image sensor 14, an image processor 16, a Range Finder (RF) 18, a controller 20, memory 22, a display 24, a User Interface (UI) 26, and a receptacle to receive a mass storage device 34. In some embodiments, the digital camera 10 may also include a Global Positioning Satellite (GPS) receiver 28, a compass 30, and a communication interface 32.

Lens assembly 12 usually comprises a single lens or a plurality of lenses, and collects and focuses light onto image sensor 14. Image sensor 14 captures images formed by the light. Image sensor 14 may be, for example, a charge-coupled device (CCD), a complementary metal oxide semiconductor (CMOS) image sensor, or any other image sensor known in the art. Generally, the image sensor 16 forwards the captured light to the image processor 16 for image processing; however, in some embodiments, the image sensor 14 may also forward the light to RF 18 so that it may calculate a range or distance to one or more objects in the captured image. As described later, the controller 20 may save this range information and use it to annotate the captured image.

Image processor 16 processes raw image data captured by image sensor 14 for subsequent storage in memory 22. From there, controller 20 may generate one or more control signals to retrieve the image for output to display 24, and/or to an external device via communication interface 32. The image processor 16 may be any digital signal processor programmed to process the captured image data.

Image processor 16 interfaces with controller 20 and memory 22. The controller 20, which may be a microprocessor, controls the operation of the digital camera 10 based on application programs and data stored in memory 22. In one embodiment of the present invention, for example, controller 20 annotates captured images processed by the image processor 16 with a variety of metadata, and then saves images and the metadata in memory 22. This data functions like keywords to allow a user to subsequently locate a particular image from a large number of images. The control functions may be implemented in a single digital signal microprocessor, or in multiple digital signal microprocessors.

Memory 22 represents the entire hierarchy of memory in the digital camera 10, and may include both random access memory (RAM) and read-only memory (ROM). Computer program instructions and data required for operation are stored in non-volatile memory, such as EPROM, EEPROM, and/or flash memory, while data such as captured images, video, and the metadata used to annotate them are stored in volatile memory.

The display 24 allows the user to view images and video captured by digital camera 10. As with conventional digital cameras 10, the display 24 displays an image or video for a user almost immediately after the user captures the image. This allows the user to preview an image or video and delete it from memory if he or she is not satisfied. According to the present invention, metadata used to annotate captured images may be displayed on display 24 along with the images. The UI 26 facilitates user interaction with the digital camera 10. For example, via the U 26, the user can control the image-capturing functions of the digital camera 10 and selectively pan through multiple captured images and/or videos stored in memory 22. With the UI 26, the user can also select desired images them to be saved, deleted, or output to an external device via the communication interface 32.

As stated above, some digital cameras 10 may come equipped with a variety of sensors such as GPS receiver 28 and compass 30. The GPS receiver 28 enables the digital camera 10 to determine its geographical location based on GPS signals received from a plurality of GPS satellites orbiting the earth. These satellites include, for example, the U.S. Global Positioning System (GPS) or NAVSTAR satellites; however, other systems are also suitable. The GPS receiver 28 is able to determine the location of the digital camera 10 by computing the relative time of arrival of signals transmitted simultaneously from the satellites. In one embodiment of the present invention, the location information calculated by the GPS receiver 28 may be used to annotate a given image, or to identify an object within the captured image.

Compass 30 may be, for example, a small solid-state device designed to determine which direction the lens 12 of the digital camera 10 is facing. Generally, compass 30 comprises a discrete component that employs two or more magnetic field sensors. The sensors detect the Earth's magnetic field and generate a digital or analog signal proportional to the orientation. Upon receipt, the controller 20 uses known trigonometric techniques to interpret the generated signal and determine the direction in which the lens 12 is facing. As described in more detail below, the controller 20 may then use this information to determine the identity of an object within the field of view of the lens 12, or to annotate an image captured by the digital camera 10.

The communication interface 32 may comprise a long-range or short-range interface that enables the digital camera 10 to communicate data and other information with other devices over a variety of different communication networks. For example, the communication interface 32 may provide an interface for communicating over one or more cellular networks such as Wideband Code Division Multiple Access (WCDMA) and Global System for Mobile communications (GSM) networks. Additionally, the communication interface 32 may provide an interface for communicating over wireless local area networks such as WiFi and BLUETOOTH networks. In some embodiments, the communication interface 32 may comprise a jack that allows a user to connect the digital camera 10 to an external device via a cable.

Digital camera 10 may also include a slot or other receptacle that receives a mass storage device 34. The mass storage device 34 may be any device known in the art that is able to store large amounts of data such as captured images and video. Suitable examples of mass storage devices include, but are not limited to, optical disks, memory sticks, and memory cards. Generally, users save the images and/or video captured by the digital camera 10 onto the mass storage device 34, and then remove the mass storage device 34 and connect it to an external device such as a personal computer. This permits users to transfer captured images and video to the external device.

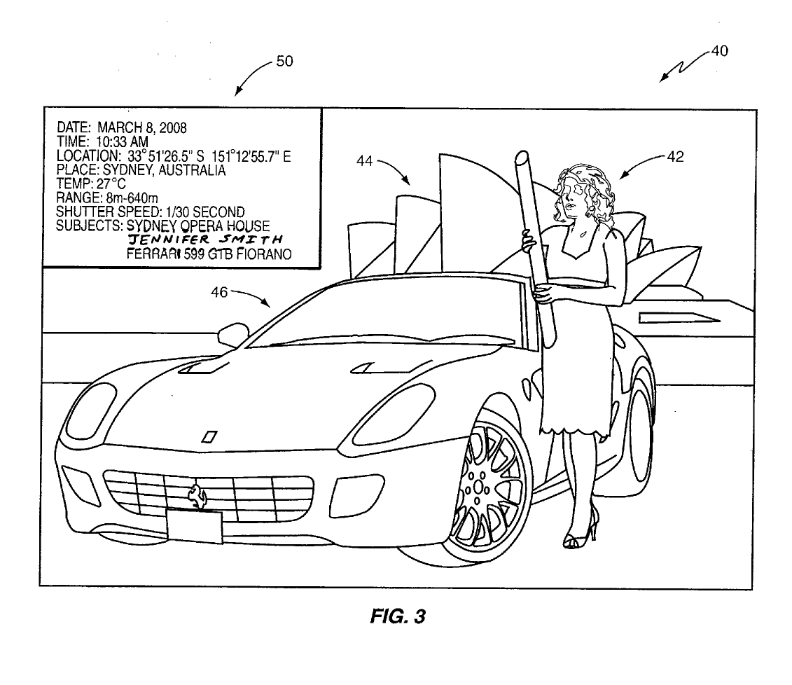

As previously stated, the digital camera 10 captures images and then analyzes the images to identify a variety of objects in the image. Different sensors associated with the digital camera 10, such as GPS 28, compass 30, and DMM 18, may provide the information that is used to identify the objects. The sensor-provided data and the resultant identification data may then be used as metadata to annotate a captured image that identifies the image. FIG. 3, for example, shows a captured image annotated with metadata displayed on the display 24 of digital camera 10.

The captured image 40 includes several objects. These are a woman 42, a famous structure 44, and an automobile 46. Image 40 may also contain other objects, however, only these three are discussed herein for clarity and simplicity. When analyzing an image, the present invention classifies the different subjects 42, 44, 46 as being either a “static” object or a “dynamic” object. Static objects are objects that generally remain in the same location over a relatively long period of time. Examples of static objects include, but are not limited to, buildings, structures, landscapes, tourist attractions, and natural wonders. Dynamic objects are objects that have at least some mobility, or that may appear in more than one location. Examples of dynamic objects include, but are not limited to, people, animals, and vehicles.

Based on its classification, the present invention selects an appropriate recognition algorithm to identify the object. The present invention may use any known technique to recognize a given static or dynamic object. However, once recognized, the digital camera 10 may use the information as metadata to annotate the image 40. In FIG. 3, for example, the digital camera 10 displays an overlay 50 that displays a variety of metadata about the image 40. Some suitable metadata displayed in the overlay 50 includes a date and time that the image was captured, the geographical coordinates of place the image was captured, and the name of the city where the image was captured. Other metadata may include data associated with the environment or with the settings of the digital camera 10 such as temperature, a range to one of the objects in the picture, and the shutter speed. Still, other metadata may identify one or more of the recognized objects in the image 40.

Here, objects 42, 44, and 46 are identified respectively using the woman's name (i.e., Jennifer Smith), the name of the structure in the background (i.e., Sydney Opera House), and the make and model of the vehicle (i.e., Ferrari 599 GTB Fiorano). This metadata, which is displayed to the user, is likely to be remembered by the user. Therefore, the present invention uses this metadata as keywords on which the user may search. For example, the user is likely to remember taking a picture of a Ferrari. To locate the picture, the user would search for the keyword “Ferrari.” The digital camera 10 would search a database for this keyword and, if found, would display the image for the user. If more than one image is located, the digital camera 10 could simply provide a list of images that match the user-supplied keyword. The user may select the desired image from the list for display.

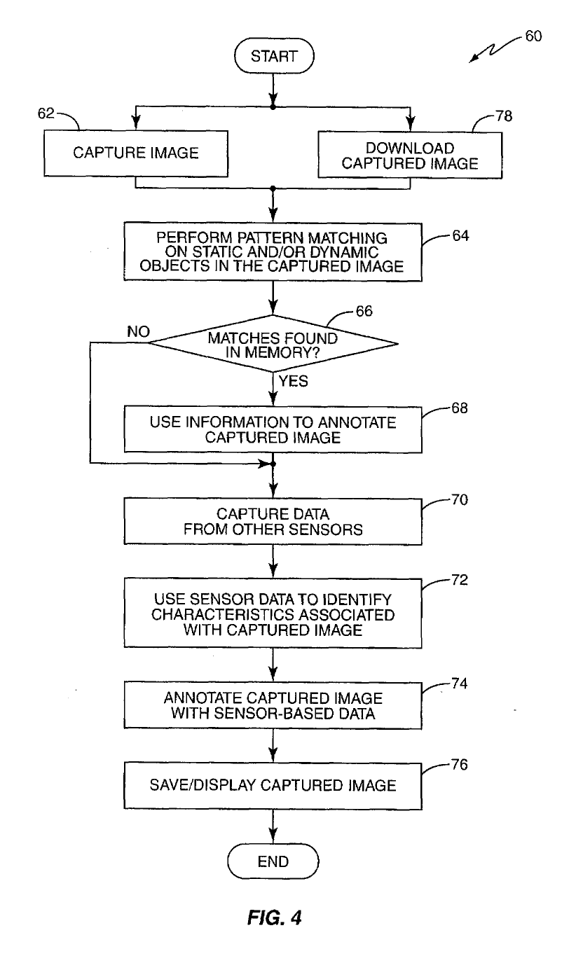

FIG. 4 illustrates a method 60 by which a digital camera 10 configured according to one embodiment of the present invention annotates a given digital image with metadata. As seen in FIG. 4, the digital camera 10 first captures an image (box 62). In one embodiment, which is described in more detail below, the captured image may be sent to, and received by, an external device for processing (box 78). However, in this embodiment, the controller 20 then analyzes the image, classifies the image objects as being static or dynamic. Based on this classification, the controller 20 selects an appropriate technique to recognize the objects (box 64).

For example, the controller 20 would classify the woman 42 and the vehicle 46 in image 40 as being dynamic objects because these objects have some mobility. The controller may perform this function by initially determining that the woman 42 has human features (e.g., a human profile or contour having arms, legs, facial features, etc.), or by recognizing that the vehicle 46 has the general outline or specific features of a car. The controller 20 would then perform appropriate image recognition techniques on the woman 42 and the vehicle 46, and compare the results to information stored in memory 22. Provided there is a match (box 66), the controller 20 could identify the name of the woman 42 and/or the specific make and model of the vehicle 46, and use this information to annotate the captured image (box 68).

Similarly, the controller 20 would classify the structure 44 in the image as a static object because it has little or no mobility. The controller 20 would then receive data and signals from the sensors in digital camera 10 such as GPS receiver 28, compass 30, and RF 18 (box 70). The controller 20 could use this sensor-provided information to determine location information, or to identify a structure 44 in the captured image (box 72).

By way of example, structure 44 is a well-known building—the Sydney Opera House. In one embodiment, the controller 20 calculates that the camera 10 is located at the geographical coordinates received from the GPS receiver 28. Based on the orientation information (e.g., north, south, east, west) provided by compass 30, the controller 20 could determine that the user is pointing lens 12 in the general direction of the Sydney Opera House. Given a distance (e.g., 300 meters), the controller 20 could identify the structure 44 as the Sydney Opera House. If there are multiple possible matches, the controller 20 could provide the user with a list of possible structures, and the user could select the desired structure. Once identified, the controller 20 could use the name of the structure to annotate the digital image being analyzed (box 74). The controller 20 could then display the captured image along with the window overlay 50 containing the metadata. The controller 20 might also save the image and the metadata in memory 22 so that the user can later search on this metadata to locate the image.

The controller 20 may perform any of a plurality of known recognition techniques to identify an object in an analyzed image. The only limits to recognizing a given dynamic object would be the resolution of the image and the existence of information that might help to identify the object. For example, the controller 20 may need to identify the name of a person in an image, such as woman 42. Generally, the user of the digital camera 10 would identify a person by name whenever the user took the person's picture for the first time by manually entering the person's full name using the UI 26. The controller 20 would isolate and analyze the facial features of that person according to a selected facial recognition algorithm, and store the resultant artifacts in memory 22 along with the person's name. Thereafter, whenever controller 10 needed to identify a person in an image, it would isolate the person's face and perform the selected facial recognition algorithm to obtain artifacts. The controller 20 would then compare the newly obtained artifacts against the artifacts stored in memory 22. If the two match, the controller 22 could identify the person using the name associated with the artifacts. Otherwise, the controller 20 might assume that the person is unknown, prompt the user to enter the person's name, and save the information to memory for use in identifying people in subsequent images.

The metadata used to annotate the digital image is associated with each individual image to facilitate subsequent searches for the image as well as its retrieval. Therefore, the metadata may be stored in a database in local memory 22 along with the filename of the image it is associated with. In some embodiments, however, the metadata is saved according to the Exchangeable Image File (EXIF) data region within the image file itself. This negates the need for additional links to associate the metadata with the image file.

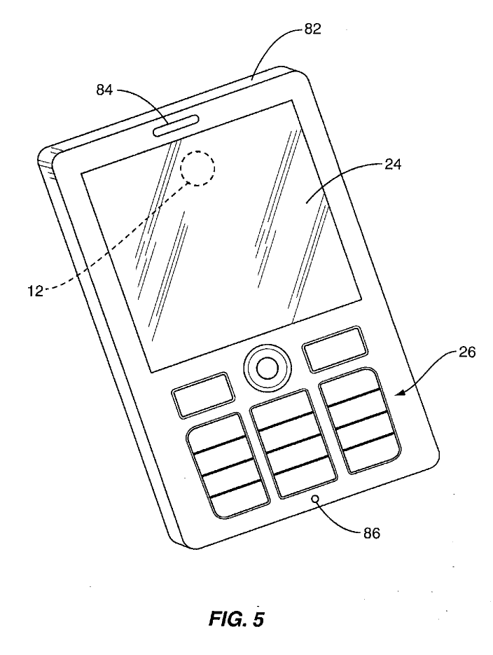

Although the previous embodiments discuss the present invention in the context of a digital camera 10, those skilled in the art should appreciate that the present invention is not so limited. Any camera-equipped device able to capture images and/or video may be configured to perform the present invention. As seen in FIG. 5, for example, the present invention may be embodied in a wireless communication device, such as camera-equipped cellular telephone 80. Cellular telephone 80 comprises a housing 82 to contain its interior components, a speaker 84 to render audible sound to the user, a microphone to receive audible sound from the user, a display 24, a UI 26, and a camera assembly having a lens assembly 12. The operation of the cellular telephone 80 relative to communicating with remote parties is well-known, and thus, not described in detail here. It is sufficient to say that the display 24 functions as a viewfinder so that the user could capture an image. Once the image is captured, the cellular telephone 80 would process the image as previously stated and annotate the image with metadata for display on display 24.

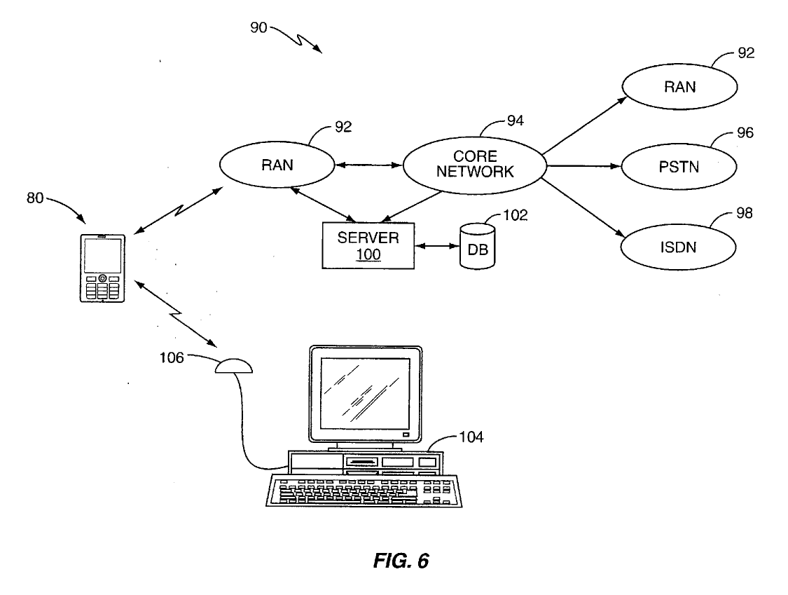

In some cases, the digital camera 10, or the cellular telephone 80, might not have the ability to classify and identify objects in an image and use that data to annotate the image. Therefore, in one embodiment, the present invention contemplates that these devices transfer their captured images to an external device where processing may be accomplished. One exemplary system 90 used to facilitate this function is shown in FIG. 6.

As seen in FIG. 6, the communication interface 32 of cellular telephone 80 comprises a long-range cellular transceiver. The interface 32 allows the cellular telephone 80 to communicate with a Radio Access network 92 according to any of a variety of known air interface protocols. For example, the communication interface 32 may communicate voice data and/or image data. A core network 94 interconnects the RAN 92 to another RAN 92, the Public Switched Telephone Network (PSTN) 96, and/or the Integrated Services Digital Network (ISDN) 98. Although not specifically shown here, other network connections are possible. Each of these networks 92, 94, 96, 98 are presented here for clarity only and not germane to the claimed invention. Further, their operation is well-known in the art. Therefore, no detailed discussion describing these networks is required. It is sufficient to say that the cellular telephone 80, as well as other camera-equipped wireless communication devices not specifically shown in the figures, may communicate with one or more remote parties via system 90.

As seen in FIG. 6, system 90 also includes a server 100 connected to a database (DB) 102. Server 100 provides a front-end to the data stored in DB 102. Such a server may be used, for example, where the digital camera 10 or the wireless communication device 80 does not have the resources available to classify and identify image objects according to the present invention. In such cases, as seen in method 60 of FIG. 4, the server 90 would download or receive an image or video captured with the cellular telephone 80 via RAN 92 and/or Core Network 94 (box 78). Once received, the server 100 would analyze the image using data stored in DB 102, and annotate the image as previously described (boxes 64-74). The server 100 would then save the image in the DB 102 for subsequent retrieval, or return it to cellular telephone 80 for storage in memory 22 or display on display 24.

In another embodiment, the communication interface 32 in the cellular telephone 80 could comprise a BLUETOOTH transceiver. In such cases, the communication interface 32 in the cellular telephone 80 might be configured to automatically transfer any images or video it captured to a computing device 104 via a wireless transceiver 106. In addition, the user may transfer the captured images and/or video to computing device 104 using the removable mass storage device 34 as previously described. Once received, the computing device 104 would execute software modules designed to analyze the digital image to identify the objects in the digital image. The computing device 104 would then save the metadata with the image and display them both to the user.

The system of FIG. 6 means that the present invention does not require that the image be annotated at the time the image is captured. Rather, the annotation data may be entered at a later time. Additionally, the previous embodiments specify certain sensors as being associated with the digital camera 10. However, these sensors may also be associated with the cellular telephone 80. Moreover, other sensors not specifically shown here are also suitable for use with the present invention. These include, but are not limited to, sensors that sense a view angle of the lens 12, a thermometer to measure the temperature at the time a picture was taken, the shutter speed, and magnetic/electric compasses.

Additionally, the present invention is not limited to annotating still images with metadata. In some embodiments, the present invention also annotates video with metadata as previously described.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of annotating digital images, the method comprising:
classifying objects in a digital image as being one of a dynamic object or a static object;
generating metadata for an object in the digital image based on a classification for the object; and
annotating the digital image with the metadata.

2. The method of claim 1 wherein classifying objects in a digital image as being one of a dynamic object or a static object comprises:
classifying movable objects as dynamic objects; and
classifying non-movable objects as static objects.

3. The method of claim 1 wherein generating metadata for an object in the digital image based on a classification for the object comprises:
digitally processing the object in the digital image according to a selected processing technique to obtain information about the object;
searching a database for the information; and
if the information is found, retrieving the metadata associated with the information.

4. The method of claim 3 further comprising selecting the processing technique used to obtain the information based on the classification of the object.

5. The method of claim 3 wherein digitally processing the object in the digital image according to a selected processing technique to obtain information about the object comprises:
determining a geographical location of a device that captured the digital image;
determining an orientation of the device when the digital image was captured;
calculating a distance between the device and the object being digitally processed; and
identifying the object based on the geographical location of the device, the orientation of the device, and the distance between the device and the object when the digital image was captured.

6. The method of claim 3 wherein the object comprises a person, and wherein generating metadata for an object comprises identifying the person using a facial recognition technique to identify the person.

7. The method of claim 6 further comprising:
receiving the identity of the person if the facial recognition technique fails to identify the person; and
saving the identity of the person in memory.

8. The method of claim 1 wherein annotating the digital image with the metadata comprises generating an overlay to contain the metadata, and displaying the overlay with the digital image to the user.

9. The method of claim 1 wherein annotating the digital image with the metadata comprises associating the metadata with the digital image, and saving the metadata and the digital image in memory.

10. The method of claim 1 further comprising receiving the digital image to be classified from a device that captured the digital image.

11. A device for capturing digital images, the device comprising:
an image sensor to capture light traveling through a lens;
an image processor to generate a digital image from the light captured by the light sensor; and
a controller configured to:
classify objects in the digital image as being one of a dynamic object or a static object;
generate metadata for an object in the digital image based on a classification for the object; and
annotate the digital image with the metadata.

12. The device of claim 11 wherein the controller classifies the objects as being one of a dynamic object or a static object based on whether the objects are mobile.

13. The device of claim 11 wherein the controller is configured to generate the metadata for an object by:
select a processing technique to obtain information about the object based on the classification of the object;
digitally process the object according to the selected processing technique;
search a database for the information; and
if the information is found, retrieve metadata associated with the information.

14. The device of claim 13 further comprising:
a Global Positioning Satellite (GPS) receiver configured to provide the controller with a geographical location of the device when the digital image is captured;
a compass configured to provide the controller with an orientation of the device when the digital image was captured; and
a distance measurement module configured to calculate a distance between the device and the object.

15. The device of claim 14 wherein the object comprises a static object, and wherein the controller is further configured to identify the static object based on the geographical location, the orientation, and the distance.

16. The device of claim 13 wherein the object comprises a person, and wherein the controller is further configured to isolate the person's face in the digital image and identify the person using a facial recognition processing technique.

17. The device of claim 16 wherein the controller is further configured to:
match the artifacts output by the facial recognition processing to artifacts stored in memory;
if the artifacts are found in memory, identify the person using information associated with the stored artifacts; and
if the artifacts are not found in memory, prompt a user to enter an identify of the person, and store the identity in memory.

18. The device of claim 11 further comprising a display configured to display the digital image and an overlay containing the metadata to a user.

19. The device of claim 11 further comprising a communication interface to transmit the digital image to an external device for processing.
